(19) United States
(12) Patent Application Publication
(10) Pub. No.: US 2008/0116138 A1
(43) Pub. Date: May 22, 2008

(54) Packing Material for Ion Chromatography

(75) Inventors: Hideyuki Kondo, Kanagawa (JP); Yoshiji Okada, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K., Minato-ku (JP)

(21) Appl. No.: 11/883,631

(22) PCT Filed: Feb. 3, 2006
(86) PCT No.: PCT/JP2006/302285

§ 371 Date: Aug. 3, 2007

Related U.S. Application Data
(60) Provisional application No. 60/650,982, filed on Feb. 9, 2005.

(30) Foreign Application Priority Data
Feb. 4, 2005 (JP) 2005-028492

(51) Int. Cl. B01D 15/08

(52) U.S. Cl. 210/656; 210/198.2; 436/161; 502/401

(57) ABSTRACT

The present invention relates to a packing material for ion chromatography, wherein a quaternary ammonium base represented by the following formula (1) is bonded to the substrate directly or through a spacer:

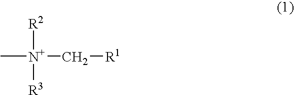

wherein R¹ represents a group having at least one olefinic double bond or conjugated double bond, each R² and R³ independently represents an organic residue which may be the same with or different from R¹; and separating equipment for chemical substances and a separating method using the packing material.

The packing material for ion chromatography, separating equipment for chemical substances and a separating method using the packing material of the present invention, enable to sufficiently separate seven standard inorganic anions and three halogen oxide anions in either of the conductometric detection or ultraviolet detection by postcolumn derivatization while preventing increase in the pressure and imposing no limitations on the measurement temperature or flow rate of mobile phase.

### CROSS REFERENCE TO THE RELATED APPLICATIONS

This is an application filed pursuant to 35 U.S.C. Section 111(a) with claiming the benefit of U.S. Provisional Application Ser. No. 60/650,982 filed Feb. 9, 2005 under the provision of 35 U.S.C. Section 111(b), pursuant to 35 U.S.C. Section 119(e)(1).

### TECHNICAL FIELD

The present invention relates to a column packing material for ion chromatography. Specifically, the present invention relates to a column packing material for ion chromatography capable of separating fluoride ion, chloride ion, nitrite ion, bromide ion, nitrate ion, sulfate ion and phosphate ion (hereinafter called “seven standard inorganic anions”) and chlorite ion, bromate ion and chlorate ion (hereinafter called “three halogen oxide anions”); to equipment for separating chemical substances using the same (which may be called “a column” hereinafter); and to a separating method using the same.

In the ion chromatography, a sample containing ion species are injected into an ion exchange column while feeding an eluent into the column filled with a packing material for ion chromatography to thereby separate various ion species according to the difference in retention time in the column and detect and determine the ions using an electrical conductivity detector and the like.

Recently, in the analysis of the three halogen oxide anions as well as the seven standard inorganic anions, ion chromatography has been used as an efficient and high-precision/high-sensitive means. Especially, bromic acid has been defined as one of the water standard criterion by Health, Labor and Welfare Ministry ordinance No. 101 (implemented on Apr. 1, 2004), and ion chromatography has been adopted as a measuring method. Bromic acid is considered to be generated by the oxdization of bromide ion due to the ozone contained in tap water and an oxidizing agent treatment of tap water. Bromic acid is seen as carcinogenic for human beings and there is concern about its adverse affects to human health.

Also, chlorous acid and chloric acid are defined as targetry items for water quality management by the same ordinance and ion chromatography is adopted as a measuring method.

In the measurement of bromic acid using ion chromatography, an accuracy of 1.0 μg/l, which is 1/10 of the water quality criteria (10.0 μg/l), is required. Therefore, a conductometric detector cannot be used for analysis, and bromic acid is separated from other ions using a column packed with anion-exchange resin as a support for separation and, after subjected to a treatment comprising two-stage reaction (postcolumn derivatization), i.e., converting bromic acid to tribromine ion using a solution of potassium bromide/sulfric acid and further securing stability in a low concentration using sodium nitrite, is detected by ultraviolet detection.

Also, with respect to the analysis of chlorous acid and chloric acid, an accuracy of 0.6 mg/l is required in conductometric detection.

As a column packing material for ion chromatography, for example, an anion exchanger introduced with tertiary amine such as triethyl amine and diethyl ethanolamine as an ion-exchange group has been disclosed (Japanese Patent Publication No. 2001-40032), which enables analysis of bromic acid to an accuracy of 1 ppb.

However, using the disclosed packing material, it was difficult to separate a bromate ion from a chlorite ion when chlorous acid was contained in a sample since the peaks of the both ions overlapped with each other. The separation of a chlorate ion from a bromide ion was also difficult.

Further, an anion exchanger introduced with tertiary heterocyclic amine as an ion-exchange group has been proposed (Japanese Patent Publication No. 2002-249517), which enables the separation of bromate ion from a chlorite ion and that of a chlorate ion from a bromide ion.

However, since it was necessary to reduce the particle size of the support resin for separation and further to increase the length of the column for sufficient separation, a pressure of 9.0 MPa or more was required and there was a problem that restrictions were imposed on the measuring temperature and flow rate of mobile phase.

### DISCLOSURE OF THE INVENTION

The present invention has been achieved under such circumstances. An object of the present invention is to provide a column packing material for ion chromatography capable of separating the three halogen oxide ions as well as the seven standard inorganic anions in either of the conductometric detection or ultraviolet detection by postcolumn derivatization, while preventing the increase in pressure and imposing no restrictions on the measuring temperature or flow rate of mobile phase; a production method thereof and a column using the same.

As a result of intensive studies to achieve the object, the present inventors have found that the seven standard inorganic anions and three halogen oxide anions can be well separated by using a packing material for ion chromatography in which a specific quaternary ammonium base is bonded to the substrate. The present invention has been accomplished based on this finding.

That is, the present invention relates to the following packing material for ion chromatography, equipment for separating chemical substances using the packing material and a separation method using the same.

1. A packing material for ion chromatography, wherein a quaternary ammonium base represented by the following formula (1) is bonded to the substrate directly or through a spacer:

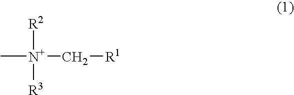

wherein R¹ represents a group having at least one olefinic double bond or conjugated double bond, R² and R³ each independently represents an organic residue which may be the same with or different from R¹.

### 2. The packing material for ion chromatography as described in 1 above, wherein R¹ is an aliphatic group or aromatic group having an olefinic double bond at the end.

### 3. The packing material for ion chromatography as described in 2 above, wherein R¹ is a vinyl, phenyl or benzyl group.

### 4. The packing material for ion chromatography as described in 1 above, wherein R² and R³ are an alkyl group having from 1 to 8 carbon atoms, which may be branched.

### 5. The packing material for ion chromatography as described in 4 above, wherein each of R² and R³ independently represents a methyl group, ethyl group or propyl group.

6. The packing material for ion chromatography as described in 1 above, wherein the quaternary ammonium base is selected from a group consisting of N,N-dimethyl allyl ammonium group, N-methyl diallyl ammonium group, triallyl ammonium group, N,N-dimethyl benzyl ammonium group and N,N-dimethyl phenethyl ammonium group.

### 7. The packing material for ion chromatography as described in 1 above, wherein the substrate is a resin containing an alcoholic hydroxyl group.

### 8. The packing material for ion chromatography as described in 1 above, wherein the substrate is polyvinyl alcohol resin.

### 9. The packing material for ion chromatography as described in 1 above, wherein the spacer is a divalent organic residue having an ether bond at both ends.

### 10. An equipment for separating chemical substances using the packing material for ion chromatography as described in 1 above.

### 11. A column filled with the packing material for ion chromatography as described in 1 above.

12. A method for separating fluoride ion, chloride ion, nitrite ion, bromide ion, nitrate ion, sulfate ion and phosphate ion; and chlorite ion, bromate ion and chlorate ion using the equipment for separating chemical substances as described in 10 above.

### 13. A method for analyzing fluoride ion, chloride ion, nitrite ion, bromide ion, nitrate ion, sulfate ion and phosphate ion; and chlorite ion, bromate ion and chlorate ion using the column as described in 11 above.

The packing material for ion chromatography of the present invention can separate the three halogen oxide ions as well as the seven standard inorganic anions with a high degree of accuracy in either of the conductometric detection or ultraviolet detection by postcolumn derivatization, while preventing the increase in pressure and imposing no restrictions on the measuring temperature or flow rate of mobile phase. Accordingly, the present invention is useful in the fields over the wide range, such as environment, food, agriculture, cosmetics, coating material, semiconductor, medicament and electric power. It is particularly useful in tap water analysis wherein the measurement of several μg/l of bromic acid is required by a Japanese ministry ordinance.

### BRIEF DESCRIPTION OF DRAWINGS

FIG. 1 The chromatogram by conductometric detection measured using the packing material for ion chromatography of Example 1.

FIG. 2 The chromatogram by ultraviolet detection (wavelength: 268 nm) measured using the packing material for ion chromatography of Example 1.

FIG. 3 The chromatogram by conductometric detection measured using the packing material for ion chromatography of Comparative Example 1.

FIG. 4 The chromatogram by ultraviolet detection (wavelength: 268 nm) measured using the packing material for ion chromatography of Comparative Example 1.

### BEST MODE TO CARRY OUT THE INVENTION

Hereinafter, the present invention is described in more details.

The packing material for ion chromatography of the present invention is an anion exchanger, wherein a quaternary ammonium base represented by the following formula (1) is bonded to the substrate directly or through a spacer:

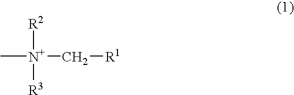

wherein R¹ represents a group having at least one olefinic double bond or conjugated double bond, preferably an aliphatic group or aromatic group having an olefinic double bond at the end, more preferably, a vinyl, phenyl or benzyl group.

R² and R³ each independently represents an organic residue which may be the same with or different from R¹, preferably an alkyl group having from 1 to 8 carbon atoms, which may be a branched one, more preferably, a methyl group, ethyl group or propyl group.

The quaternary ammonium base is preferably selected from a group consisting of N,N-dimethyl allyl ammonium group, N-methyl diallyl ammonium group, triallyl ammonium group, N,N-dimethyl benzyl ammonium group and N,N-dimethyl phenethyl ammonium group. Among these, N,N-dimethyl allyl ammonium group and N,N-dimethyl benzyl ammonium group are specifically preferable since they are capable of separating anion ions well with a good balance.

In the present invention, a substrate means a material capable of fixing on its surface a functional group represented by formula (1), and there is no specific limitation on its ingredients, size or shape. However, taking into account the packing property to a column, handling properties and strength, it is preferably a spherical shape having a diameter of 1 to 30 μm. It is also preferable to have a strength withstanding a high pressure of 1 to 30 Mpa. For the ingredient, porous crosslinked or non-crosslinked resin or silica gel is preferable. In order to analyze the seven standard inorganic anions and three halogen oxide anions within 15 minutes, resin containing an alcoholic hydroxyl group is specifically preferable.

The substrates to be used in the present invention include polyvinylalcohol resin which is obtained by saponifying an ester group of a cross-linked copolymer comprising a carboxylic acid vinyl ester and a cross-linking monomer or by converting the ester group to an alcoholic hydroxyl group. Examples of the carboxylic acid vinyl ester include vinyl acetate, vinyl propionate, vinyl butyrate, vinyl valerate and vinyl pivalate. These are used individually or in combination of two or more thereof. Among these, preferred are vinyl acetate and vinyl propionate which are relatively hydrophilic and facilitate the polymerization and saponification.

In the present invention, a spacer is a chemical bond site to be used to control the distance between the surface of the substrate and the quaternary ammonium group. The spacer is used to impart the function of preventing the interference between the ion represented by formula (1) and the substrate, and the diffusion of the peak. When the substrate is a substance containing a hydroxyl group, the spacer is preferably a bivalent organic residue having an ether bond at each of the both ends. A substance to be used to introduce a spacer to the substrate is preferably a compound containing a glycidyl group, specifically, the substance includes epichlorohydrin, 1,4-butanediol diglycidyl ether, ethylene glycol diglycidyl ether and glycerol diglycidyl ether. The introduction of a compound containing a glycidyl group is performed by a reaction of adding the above-mentioned compound from 0.1 to five times volume of the substrate in the absence of a solvent or in a solvent such as dimethyl sulfoxide together with the substrate and stirring the mixture uniformly.

The packing material for ion chromatography (an anion exchanger) of the present invention is produced by introducing a tertiary amine corresponding to the quaternary ammonium base to the substrate directly or through a spacer. The examples of the tertiary amine include N,N-dimethyl allyl amine, N-methyl diallyl amine, triallyl amine, N,N-dimethyl benzyl amine and N,N-dimethyl phenethyl amine.

The introduction of an amino group is performed by a reaction of adding the amine from 1.0 to 12.0% (vol/wt) of the substrate in water or a solvent such as dioxane and stirring the mixture uniformly.

Examples of the form of the packing material for ion chromatography of the present invention include a pellicular-type ion exchanger and a porous chemical-bond type ion exchanger. The specific examples of the perllicular-type ion exchanger include the one wherein a sulfonated polystyrene substrate is covered with latex to which the above-mentioned quaternary ammonium group is introduced. The specific example of the porous chemical-bond type ion exchanger include the one wherein a quaternary ammonium group is introduced to a polyvinyl alcoholic copolymer through a spacer.

The diameter of the packing material for ion chromatography of the present is 1 to 30 μm, preferably 2 to 20 μm, more preferably 2 to 10 μm. When the diameter is less than 1 μm, the pressure in the column at flowing the eluent greatly rises and packing the material to the column is extremely difficult. Meanwhile, when the diameter exceeds 30 μm, it is not preferable since the theoretical plate number of the column becomes lower. A weight-average particle diameter can be measured using a Coulter counter and the like.

The packing of the packing material for ion chromatography of the present invention is performed according to a known packing method such as a slurry method thereby to obtain a column for a suppressor system ion chromatography. The obtained column for a suppressor system ion chromatography can well separate seven standard inorganic anions and three halogen oxide anions at room temperature by appropriately selecting the exchange capacity of the packing material for ion chromatography and a concentration of a carbonated eluent comprising sodium carbonate, sodium hydrogen carbonate and the like.

### EXAMPLES

Hereinafter, the present invention will be described in more detail by examples. However, they are merely exemplary and the present invention should not be construed as being limited thereto.

### Production Example 1

### Polyvinyl Alcoholic Resin (Substrate)

A uniformly mixed solution containing 100 g of vinyl acetate, 180 g of triallyl isocyanurate, 150 g of butyl acetate and 10 g of 2,2′-azobis(isobutyronitrile), and 1,400 ml of water having dissolved therein 14 g of polyvinyl alcohol and 1 g of sodium phosphate were charged into a 5 L-volume three-neck flask equipped with a reflux condenser and the resulting mixed solution was stirred for 10 minutes. Subsequently, while stirring under nitrogen stream, polymerization was performed at 60° C. for 16 hours to obtain a particulate polymer. This polymer was filtered, washed, extracted with acetone, and then dried. The obtained polymer was charged together with 3 L solution of sodium hydroxide into a 5 L-volume three-neck flask equipped with a reflux condenser, a nitrogen inlet tube and a stirrer, and saponified while stirring at 15° C. for 20 hours under nitrogen stream. The resulting polymer was again filtered, washed and dried. In the polyvinyl alcohol copolymer obtained by the saponification, the density of hydroxyl group was 2.1 meq/g.

### Packing Material for Ion Chromatography:

Into 1 L-volume three-neck flask equipped with a nitrogen inlet tube and a stirrer, 100 g of the dry polymer obtained above, 300 g of 1,4-butanediol diglycidyl ether (hereinafter referred to as “1,4-BGE”) and 300 g of dimethyl sulfoxide were charged. The resulting mixture was stirred at 35° C. for 12 hours under nitrogen stream to introduce a glycidyl group-containing group into the polymer substrate. After the introduction, the polymer was washed with dimethyl sulfoxide and with water and then dried by a vacuum dryer. The mass of the dried polymer was 110 g and thus, the increment from the original substrate was 10%.

Into a 1 L-volume three-neck flask equipped with a nitrogen inlet tube and a stirrer, 100 g of the polymer having introduced thereinto a glycidyl group-containing group, 4.0 g of N,N-dimethylallylamine, and 500 ml of water were charged. The resulting solution was stirred at 40° C. for two hours to introduce an amine group, thereby preparing a packing material for ion chromatography. This packing material was washed with 1N hydrochloric acid and with 1N sodium hydroxide solution, by providing intervention of a water-washing step between respective washing operations. Thereafter, the packing material was immersed in a solution (1000 ml) of 180 mmol sodium carbonate/1700 mmol sodium hydrogen carbonate and treated at 100° C. for two hours, followed by water washing and drying. The obtained packing material for ion chromatography had a particle diameter of 9 μm and an ion exchange capacity of about 30 μeq/g.

### Production Example 2

Into a 1 L-volume three-neck flask equipped with a nitrogen inlet tube and a stirrer, 100 g of the polymer having introduced thereinto a glycidyl group-containing group which was prepared in Production Example 1, 4.0 g of N,N-dimethylbenzylamine and 500 ml of water were charged. The resulting solution was stirred at 40° C. for two hours to introduce an amine group, thereby producing a packing material for ion chromatography. This packing material was washed with 1N hydrochloric acid and with 1N hydroxide solution, by providing intervention of a water-washing step between respective washing operations. Thereafter, the packing material was immersed in a solution (1000 ml) of 180 mmol sodium carbonate/170 mmol sodium hydrogen carbonate and treated at 100° C. for two hours, followed by water washing and drying. The obtained packing material for ion chromatography had a particle diameter of about 5 μm and an ion exchange capacity of about 30 μeq/g.

### Example 1

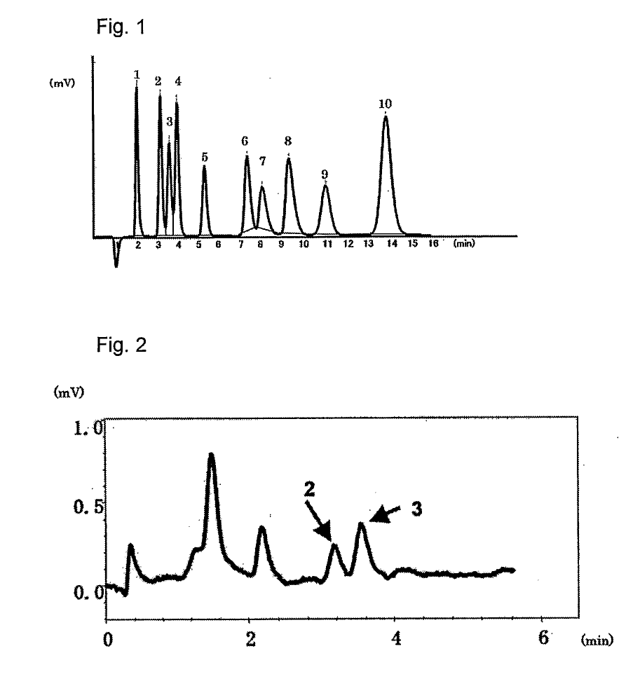

The packing material for ion chromatography obtained in the above Production Example 1 was packed in a polyether ether ketone resin (PEEK)-made column having an inside diameter of 4.0 mm and a length of 100 mm to prepare an anion exchange column. Using Compact IC761 (manufactured by Metrohm AG) equipped with a suppressor as the ion chromatograph, a solution of 1.8 mmol sodium carbonate/1.7 mmol sodium hydrogen carbonate as an eluent was passed at 1.0 ml/min and 20 μl of an aqueous solution containing 2 mg/L of F⁻, 3 mg/L of Cl⁻, 5 mg/L of NO₂⁻, 10 mg/L of Br⁻, 10 mg/L of NO₃⁻, 15 mg/L of HPO₄²⁻, 15 mg/L of SO₄²⁻, 10 mg/L of ClO₂⁻, 10 mg/L of BrO₃⁻ and 10 mg/L of ClO₃⁻, and was injected as sample of a standard solution into the ion chromatograph at a column temperature of 25° C. FIG. 1 shows the chromatogram obtained by conductometric detection. Each of reference numbers 1 to 10 in the Figure respectively represents the peak of F⁻ (1), ClO₂⁻ (2), BrO₃⁻ (3), Cl⁻ (4), NO₂⁻ (5), Br⁻ (6), ClO₃⁻ (7), NO₃⁻ (8), HPO₄²⁻ (9) or SO₄²⁻ (10). The chromatogram proves that Br⁻ (6 in FIG. 1) and ClO₃⁻ (7 in FIG. 1) are separated.

### Example 2

Using the column and ion chromatography in Example 1, the above solution as an eluent was passed at 1.0 ml/min and 200 μl of an aqueous solution containing 10 mg/L of ClO₂⁻ and 10 mg/L of BrO₃⁻ was injected as a standard solution into the ion chromatograph at a column temperature of 25° C. After subjecting the effluent to the postcolumn derivatization as described below, it was measured by an ultraviolet detector (wavelength: 268 nm). The obtained chromatogram is shown in FIG. 2, which proves that ClO₂⁻ (2 in FIG. 2) and BrO₃⁻ (3 in FIG. 2) are separated.

### Postcolumn Derivatization:

After a solution of 1.5 mol potassium bromide/1.0 mol sulfuric acid (flow rate: 0.4 ml/min) was mixed at 40° C., and then a solution of 1.2 mmol sodium nitrite (flow rate: 0.2 ml/min) was mixed at 40° C., the mixture was passed through a coil made of polyether ether ketone (PEEK) resin having an inner diameter of 0.5 mm and length of 2.0 m to initiate a reaction to convert bromic acid to a tribromine ion at 40° C.

### Example 3

The packing material for ion chromatography obtained in Production Example 2 was charged into the same column as in Example 1, and measured by the same way as in Example 1. Br⁻ and ClO₃⁻, and BrO₃⁻ and ClO₂⁻ were proved to be separated in either measurement method by conductometric detection and ultraviolet detection.

### Comparative Example 1

Into a 1 L-volume three-neck flask equipped with a nitrogen inlet tube and a stirrer, 100 g of the polymer having introduced thereinto a glycidyl group-containing group prepared in Production Example 1 as a substrate, 4.0 g of 28% trimethylamine and 500 ml of water were charged. The resulting solution was stirred at 40° C. for two hours to introduce an amine group, thereby producing a packing material for ion chromatography. This packing material was washed with 1N hydrochloric acid and with 1N sodium hydroxide solution, by providing intervention of a water-washing step between respective washing operations. Thereafter, the packing material was immersed in a solution (1000 ml) of 180 mmol sodium carbonate/170 mmol sodium hydrogen carbonate and treated, at 100° C. for two hours, followed by water washing and drying. The obtained packing material for ion chromatography had a particle diameter of 5 μm and an ion exchange capacity of about 20 μeq/g.

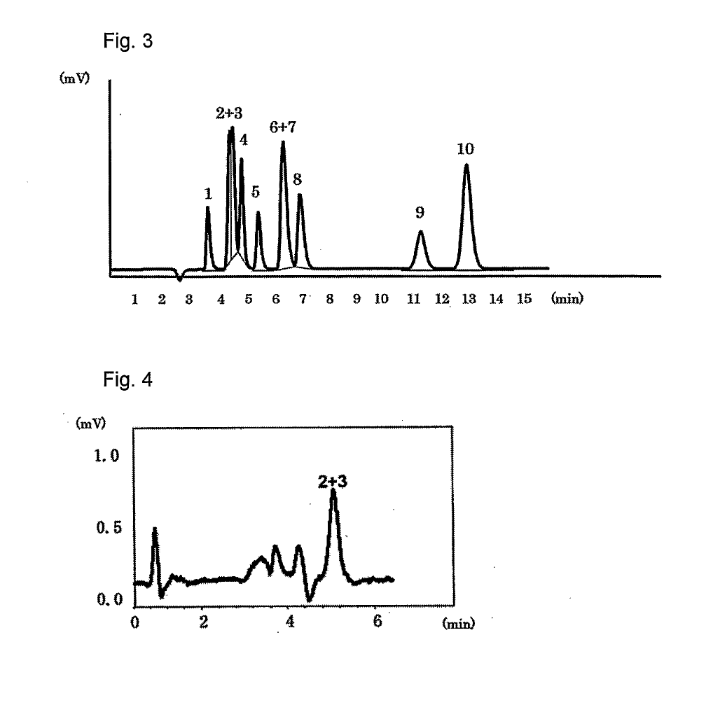

The obtained packing material for ion chromatography was charged into a column made of polyether ether ketone (PEEK) resin having an inner diameter of 4.0 mm and length of 250 mm and measured by the same way as in Example 1. Br⁻ and ClO₃⁻, and BrO₃⁻ and CO₂⁻ were not separated in either measurement method by conductometric detection and ultraviolet detection by postcolumn derivatization. The chromatogram obtained by conductometric detection is shown in FIG. 3 and that obtained by ultraviolet detection in FIG. 4. The reference numbers in each Figure have the same meanings as those in FIG. 1.

As seen in FIGS. 1 to 2, the packing material for ion chromatography of the present invention can well separate seven standard inorganic anions and three halogen oxide anions in either measurement by a conductometric detector and ultraviolet detector under conditions of using a column of 100 mm in length without limitations on the measurement temperature or flow rate of mobile phase. Since it is used in a short column, the pressure can be controlled at 5.0 MPa or lower. Moreover, the packing material enables to detect bromic acid well at a concentration of 1.0 μg/L, which is the precision of analysis (the lower limit of detection is about 0.3 μg/L).

On the other hand, despite the fact that the column shown in Comparative Example 1 is 250 mm in length, which is 2.5 times longer than the column in Examples, Br⁻ and ClO₃⁻, and BrO₃⁻ and ClO₂⁻ were not separated in either measurement by a conductometric detector and ultraviolet detector.

1. A packing material for ion chromatography, wherein a quaternary ammonium base represented by the following formula (1) is bonded to the substrate directly or through a spacer: 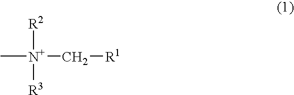
wherein R¹ represents a group having at least one olefinic double bond or conjugated double bond, R² and R³ each independently represents an organic residue which may be the same with or different from R¹.

2. The packing material for ion chromatography as claimed in claim 1, wherein R¹ is an aliphatic group or aromatic group having an olefinic double bond at the end.

3. The packing material for ion chromatography as claimed in claim 2, wherein R¹ is a vinyl, phenyl or benzyl group.

4. The packing material for ion chromatography as claimed in claim 1, wherein R² and R³ are an alkyl group having from 1 to 8 carbon atoms, which may be branched.

5. The packing material for ion chromatography as claimed in claim 4, wherein each of R² and R³ independently represents a methyl group, ethyl group or propyl group.

6. The packing material for ion chromatography as claimed in claim 1, wherein the quaternary ammonium base is selected from a group consisting of N,N-dimethyl allyl ammonium group, N-methyl diallyl ammonium group, triallyl ammonium group, N,N-dimethyl benzyl ammonium group and N,N-dimethyl phenethyl ammonium group.

7. The packing material for ion chromatography as claimed in claim 1, wherein the substrate is a resin containing an alcoholic hydroxyl group.

8. The packing material for ion chromatography as claimed in claim 1, wherein the substrate is polyvinyl alcohol resin.

9. The packing material for ion chromatography as claimed in claim 1, wherein the spacer is a divalent organic residue having an ether bond at both ends.

10. An equipment for separating chemical substances using the packing material for ion chromatography as claimed in claim 1.

11. A column filled with the packing material for ion chromatography as claimed in claim 1.

12. A method for separating fluoride ion, chloride ion, nitrite ion, bromide ion, nitrate ion, sulfate ion and phosphate ion; and chlorite ion, bromate ion and chlorate ion using the equipment for separating chemical substances as claimed in claim 10.

13. A method for analyzing fluoride ion, chloride ion, nitrite ion, bromide ion, nitrate ion, sulfate ion and phosphate ion; and chlorite ion, bromate ion and chlorate ion using the column as claimed in claim 11.
